(19) United States
(12) Patent Application Publication
(10) Pub. No.: US 2026/0348490 A1
(43) Pub. Date: Nov. 5, 2026

(54) REED VALVE HAVING REDUCED VORTEX SHEDDING

(71) Applicant: PHINIA JERSEY HOLDINGS LLC, Wilmington, DE (US)

(72) Inventors: Francisco Romo, Ciudad Juarez (MX); Karla Elizabeth Ramirez Montañez, Ciudad Juarez (MX)

(21) Appl. No.: 19/198,221

(22) Filed: May 5, 2025

(51) Int. Cl. F16K 47/02; F16K 15/16; H01M 8/04082; H01M 8/04089; H01M 8/04119; H01M 8/1004

(52) U.S. Cl. CPC F16K 47/02; F16K 15/162; H01M 8/04097; H01M 8/04156; H01M 8/04201; H01M 8/1004

(57) ABSTRACT

A reed valve includes a valve body, and a reed petal including a mounting portion and an adjacent flapper portion. The mounting portion is mounted on the valve body. The valve body includes a flow window opening and has a surface surrounding a periphery of the flow window opening that defines a valve seat for the reed petal. The flapper portion includes a peripheral edge extending continuously from one end of the mounting portion to an opposite end of the mounting portion. The peripheral edge includes a plurality of sides, and at least one of the sides is sloped inward. The flapper portion is moveable between a closed disposition and an open disposition. In the open disposition, the peripheral edge of the flapper portion reduces vortex shedding in a flow of gas downstream from the flow window opening. A fuel cell system including the reed valve is also provided.

### FIELD OF THE INVENTION

The disclosure generally relates to reed valves and, more specifically, to reed valves that regulate the flow of gases such as in hydrogen fuel cell systems.

### BACKGROUND OF THE INVENTION

A reed valve is a one-way valve that allows for the flow of gaseous fluids in one direction while preventing the flow of the gaseous fluids in the opposite direction. One application for a reed valve is in a hydrogen fuel cell system in which the reed valve regulates the flow of gases including hydrogen gas. During operation of the fuel cell system, the reed valve may cause a phenomenon known as vortex shedding. In fluid dynamics, vortex shedding is the repeated shedding, or breaking away, of vortices in the form of swirling fluid patterns, from a body due to the drag created by the body as fluid flows around it. The shedding of these vortices causes alternating high and low pressure regions that induce vibrations in the body and/or surrounding structures. In the case of reed valves, the flow of gases through the reed valve generates turbulent flow around the flexible diaphragm, or reed petal, of the reed valve, causing it to deflect and leading to the formation of the swirling vortices on the downstream side of the reed petal and subsequently an alternating pressure pattern.

These oscillating vortices and associated pressure pulses are undesirable. The turbulence caused by the vortex shedding can create drag on the reed petal that reduces the efficiency of the reed valve and represents an increase in energy loss. The pressure pulses caused by vortex shedding can also induce vibrations in the reed petal, which may lead to fatigue and premature wear of the reed valve. This effect is exacerbated in high-speed engine applications in which the reed valve opens and closes rapidly. Vortex shedding may also cause irregular or inconsistent movement of the reed petal, which can lead to improper sealing or inefficient flow through the reed valve. Additionally, at certain flow speeds, the pressure pulses caused by vortex shedding may synchronize with the natural frequency of the reed valve, which can cause resonant vibrations that amplify the oscillations and may affect performance and mechanical integrity of the reed valve. Therefore, a need exists for a reed valve that reduces the degree of vortex shedding caused by the reed petal of the valve during operation.

### BRIEF SUMMARY

An improved reed valve for one-way flow of gas is provided. The reed valve includes a valve body and a reed petal including a mounting portion and an adjacent flapper portion. The mounting portion is mounted on the valve body. The valve body includes a flow window opening and has a surface surrounding a periphery of the flow window opening that defines a valve seat for the reed petal. The flapper portion of the reed petal includes a peripheral edge extending continuously from one end of the mounting portion of the reed petal to an opposite end of the mounting portion. The peripheral edge includes a plurality of sides, and at least one of the sides is sloped inward. The flapper portion is moveable between a closed disposition, in which the flapper portion is seated on the valve seat and an open disposition, in which the flapper portion is lifted away from the valve seat. In the open disposition, the peripheral edge of the flapper portion reduces vortex shedding in a flow of gas downstream from the flow window opening of the reed valve. The flapper portion may therefore provide one or more of increasing the efficiency of the reed valve, reducing noise generated by the reed valve, and improving the durability of the reed valve.

In specific embodiments, the at least one side of the peripheral edge is arcuately curved inward.

In specific embodiments, the peripheral edge includes at least three corners, and each of the plurality of sides of the peripheral edge extends between two neighboring corners.

In particular embodiments, the peripheral edge includes four corners and three sides, and each of the three sides extends between two neighboring corners.

In certain embodiments, each of the three sides of the peripheral edge is arcuately curved inward.

In particular embodiments, i) one or more of the corners of the peripheral edge is rounded; ii) one or more of the corners of the peripheral edge is pointed; or iii) both i) and ii).

In particular embodiments, the at least one side of the peripheral edge is bent inward from two neighboring corners to a point.

In certain embodiments, the at least one side of the peripheral edge is V-shaped.

In specific embodiments, the flapper portion of the reed petal is larger than the mounting portion of the reed petal.

In specific embodiments, the flapper portion of the reed petal has a generally quadrilateral shape.

In specific embodiments, the flow window opening in the valve body is generally quadrilateral in shape.

In particular embodiments, the flow window opening in the valve body has four sides, each side being straight.

In specific embodiments, the reed valve further includes a limiter mounted on the valve body. The reed petal is disposed between the valve body and the limiter.

In particular embodiments, the limiter includes a base and an adjacent stop. The base is mounted on the valve body. The stop extends at an angle from the base and is spaced from the valve body.

A fuel cell system is also provided. The fuel cell system includes a fuel cell stack including a membrane electrode assembly, a cathode air supply subsystem that supplies air to the fuel cell stack, and an anode hydrogen supply subsystem that supplies hydrogen gas to the fuel cell stack. The anode hydrogen supply subsystem includes a source of high-pressure hydrogen gas and an ejector having an inlet connected to the source of high-pressure hydrogen gas and an outlet connected to an anodic inlet of the fuel cell stack. The anode hydrogen supply subsystem further includes an anodic recirculation subsystem. The anodic recirculation subsystem includes a water separator having an inlet connected to an anodic outlet of the fuel cell stack, and a reed valve as described in any of the embodiments above disposed between the water separator and an inlet of the ejector.

In specific embodiments, the reed valve is assembled directly between the water separator and the ejector.

In specific embodiments, the reed valve is press fit between the water separator and the ejector.

### DESCRIPTION OF THE DRAWINGS

Various advantages and aspects of this disclosure may be understood in view of the following detailed description when considered in connection with the accompanying drawings, wherein:

FIG. 1 is a schematic view of a hydrogen gas full cell system in accordance with embodiments of the disclosure;

FIG. 2 is a perspective view of a reed valve in accordance with embodiments of the disclosure as viewed from above, for use in, for example, the fuel cell system;

FIG. 3 is a perspective view of the reed valve of FIG. 2 as viewed from below;

FIG. 4 is a perspective view of the reed valve of FIG. 2 as viewed from the side;

FIG. 5 is a sectional view of the reed valve of FIG. 2;

FIG. 6 is an exploded view of the reed valve of FIG. 2

FIG. 7 is a plan view of a reed petal of the reed valve of FIG. 2;

FIG. 8 is a plan view of a reed petal of a reed valve in accordance with other embodiments of the disclosure;

FIG. 9 is a plan view of a reed petal of a reed valve in accordance with yet other embodiments of the disclosure;

FIG. 10 is a graph of a pressure pulsation through a fully open reed valve having a conventional reed petal and a reed petal according to the embodiments of FIGS. 7-9;

FIG. 11 is a graphical view of gas flow velocity through a conventional reed valve and a reed valve according to the embodiments of FIG. 2;

FIG. 12A is a graphical view of gas flow turbulence through a conventional reed valve and a reed valve according to the embodiments of FIG. 2; and

FIG. 12B is another graphical view of gas flow turbulence through a conventional reed valve and a reed valve according to the embodiments of FIG. 2.

### DETAILED DESCRIPTION OF THE INVENTION

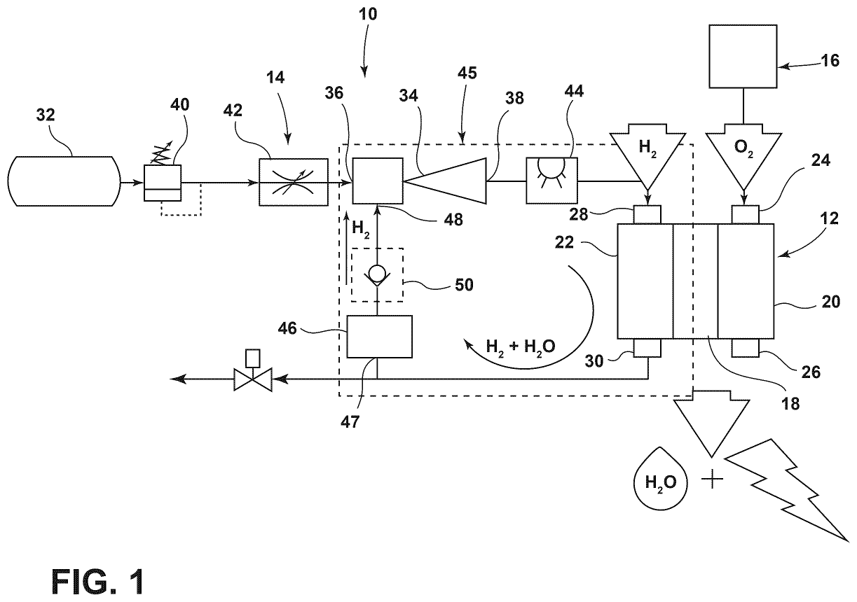

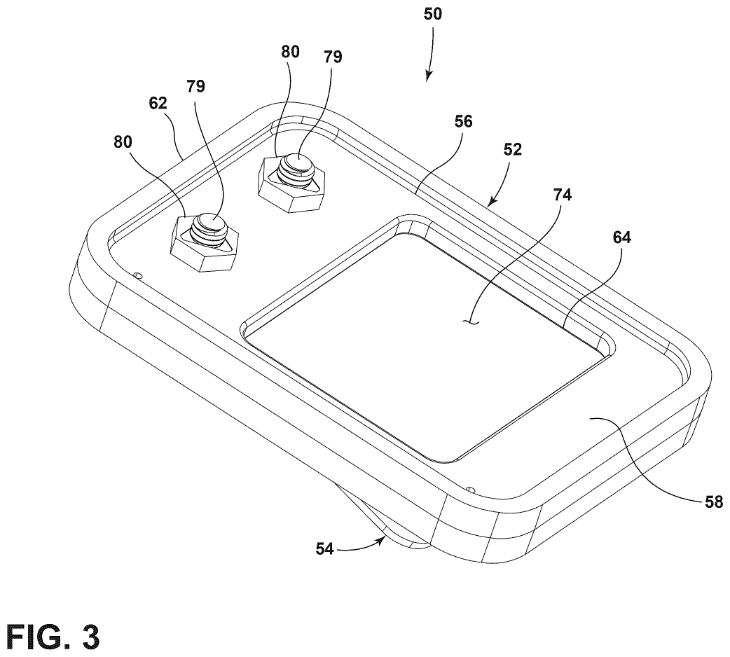

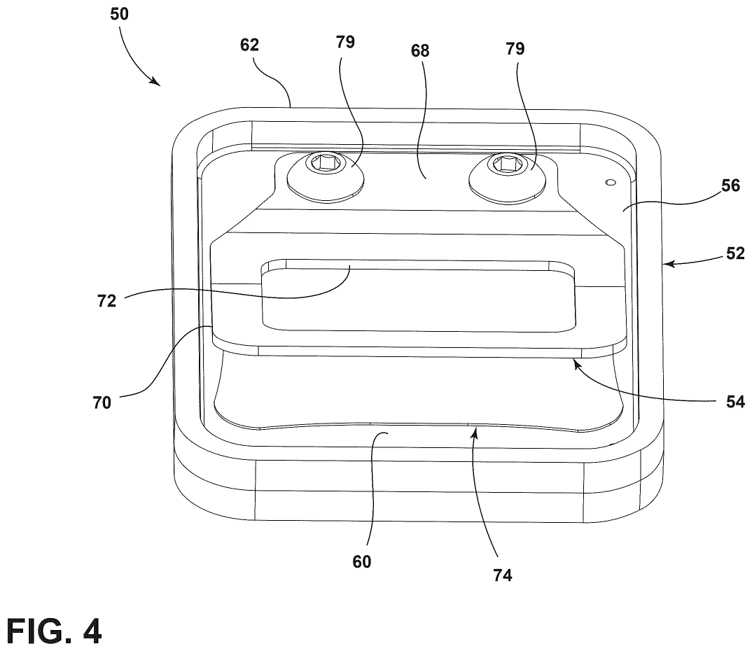

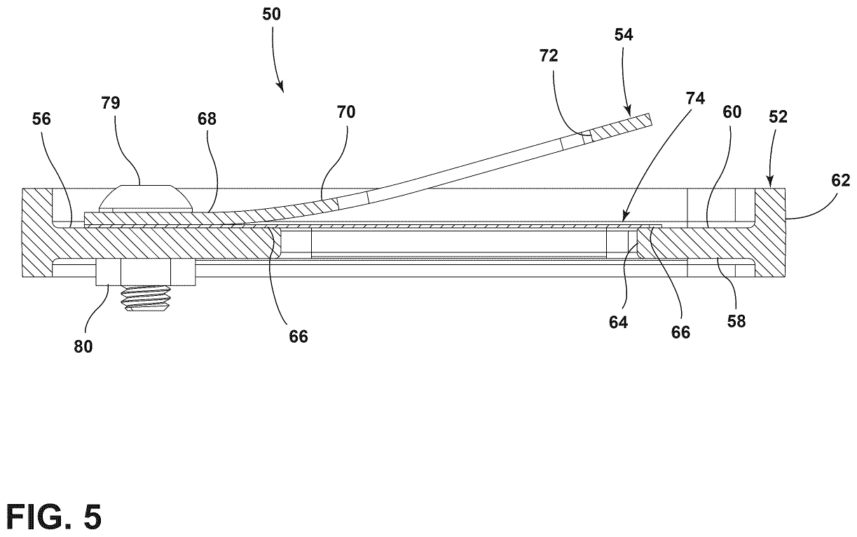

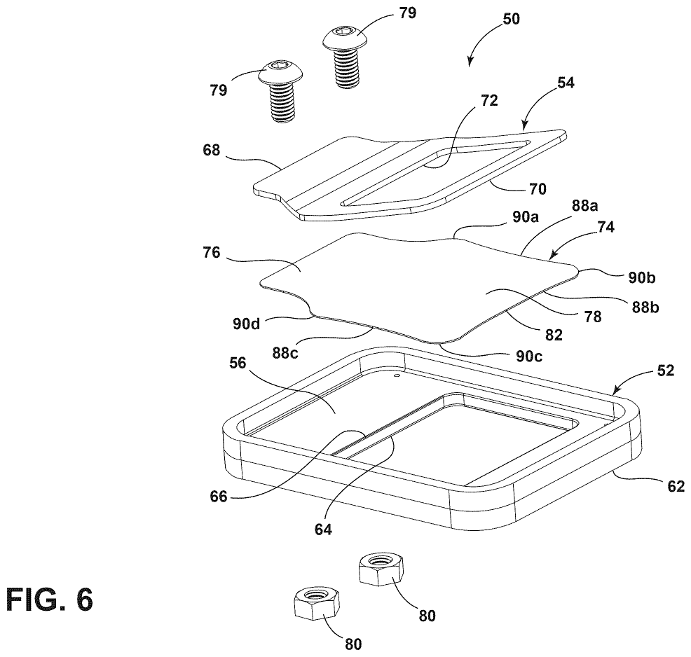

A reed valve providing lower, reduced vortex shedding and a hydrogen fuel cell system including the reed valve are disclosed. Referring to FIGS. 1-12B, wherein like numerals indicate corresponding parts throughout the several views, the reduced vortex-shedding reed valve (also referred to herein as simply the reed valve) is illustrated and generally designated as 50. The reed valve 50 reduces the velocity, pressure, and/or turbulence of gas flow around the reed valve, thereby reducing the amount of flow separation and swirling vortex formation downstream of reed valve and thus reducing vortex shedding.

With reference first to FIG. 1, a fuel cell system 10 may be used, for example, to provide electrical power, for example, to an electric motor of an electric vehicle (EV) or hybrid electric vehicle (HEV). The fuel cell system 10 generally includes a fuel cell stack 12, an anode hydrogen supply subsystem 14 that supplies hydrogen gas to the fuel cell stack 12, and a cathode air supply subsystem 16 that supplies air to the fuel cell stack 12. The fuel cell stack 12 includes a membrane electrode assembly (MEA) 18 that has a cathode side 20 and an anode side 22. The cathode side 20 has a cathodic inlet 24 that receives the supply of air from the cathode air supply subsystem 16, and a cathodic outlet 26. The anode side 22 has an anodic inlet 28 that receives the supply of hydrogen gas from the anode hydrogen supply subsystem 14, and an anodic outlet 30. The anode hydrogen supply subsystem 14 includes a source of high-pressure hydrogen gas in the form of a high-pressure hydrogen tank 32. The anode hydrogen supply subsystem 14 also includes an ejector 34 having an inlet 36 connected to the high-pressure hydrogen tank 32 and an outlet 38 connected to the anodic inlet 28 of the fuel cell stack 12. A high-pressure regulator 40 and a flow control valve 42 may be connected in-line with and between the high-pressure hydrogen tank 32 and the ejector 34. Also, a humidifier 44 may be connected between the ejector 34 and the anodic inlet 28 of the fuel cell stack 12. The anode hydrogen supply subsystem 14 further includes an anodic recirculation subsystem (ARS) 45 in the form of a loop between the anodic outlet 30 and the anodic inlet 28 of the fuel cell stack 12. The ARS 45 includes a water separator 46 having an inlet 47 connected to the anodic outlet 30, and the ejector 34. The ARS 45 also includes the reed valve 50 disposed between the water separator 46 and an inlet 48 of the ejector 34, which inlet 48 may be separate from the inlet 36 of the ejector 34 and may be in fluid communication with the outlet 38 of the ejector 34. The reed valve 50 allows for one-way flow of gas from the water separator 46 to the ejector 34 and prevents backflow of gas from the ejector 34 back to the water separator 46. The reed valve 50 may be assembled directly between the water separator 46 and the ejector 34. For example, the reed valve 50 may be inserted into a counterbore in the water separator 46 and press fit into the counterbore by being compressed by a lip of the ejector 34. The water separator 46 and ejector 34 may then be tightened together by fasteners such as four M6 screws torqued at 10 Nm. Thus, the water separator 46, ejector 34, and reed valve 50 may be assembled together as one unitary subassembly in which non-combusted hydrogen gas is recycled from the fuel cell stack 12 into the water separator 46, through the reed valve 50 to the ejector 34 where it can mix with the high-pressure hydrogen gas supplied from the high-pressure hydrogen tank 32 and delivered back to the fuel cell stack 12. Water is a byproduct of hydrogen combustion in the fuel cell stack 12 and is undesirable in the fuel cell system 10 since it reduces the efficiency of the fuel cell stack 12. Water that is mixed with the hydrogen gas in the ARS 45 is separated by the water separator 46 and removed from the system 10.

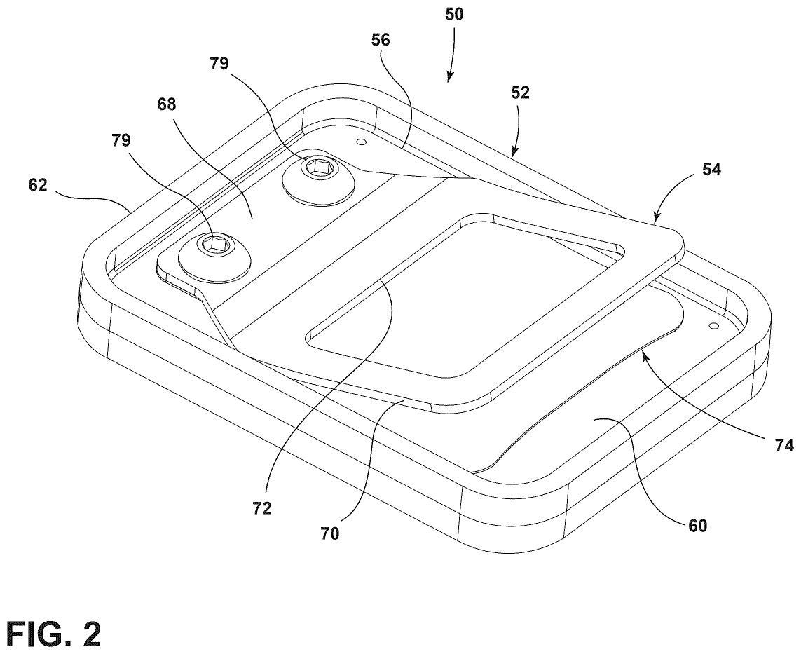

Turning next to FIG. 2-7, the reed valve 50 includes a valve body 52 and a limiter 54 mounted on the valve body 52. The valve body 50 is not limited to a particular shape, but as shown by way of example only, the valve body may have a generally rectangular shape and may include a generally planar central portion 56 having a first side 58 and an opposite second side 60, and a raised sidewall 62 extending around the perimeter of the central portion 56. A flow window opening 64 is formed in the central portion 56 of the valve body 52 and allows for passage of material from the first side 58 of the central portion 56 to the second side 60 of the central portion 56. The flow window opening 64 may be offset to one end of the central portion 56 of the valve body 52. A surface of the second side 60 of the central portion 56 that surrounds the periphery of the flow window opening 64 defines a valve seat 66 of the reed valve 50. The valve body 52 may be generally rigid, and may be formed of a polymer material, a metal material, or a rubber material.

The limiter 54 is a plate having an angled shape and includes a base 68 and a stop 70 that extends at an angle from the base 68. The base 68 is mounted on the central portion 56 of the valve body 52 to one side of the flow window opening 64, and the stop 70 extends outwardly and upwardly from the base 68 and is disposed above the flow window opening 64. As such, the distance between the stop 70 and the central portion 56 of the valve body 52 increases in a direction away from the base 68. The limiter 54 may also include an opening 72 in the stop 70. The opening 72 may generally coincide in shape with the flow window opening 64 in the valve body 52, but the opening 72 in the stop 70 may be smaller in dimensions than the flow window opening 64 such that when viewed from above or below, the perimeter of the opening 72 is completely within the boundary of the flow window opening 64. The limiter 54 may be formed of, for example, a rigid material such as a metal material.

A flexible reed petal 74 is disposed between the valve body 52 and the limiter 54. The reed valve may be formed of an elastic material such as an elastic polymer or rubber material. The reed petal 74 includes a mounting portion 76 and an adjacent flapper portion 78. The flapper portion 78 is larger than the mounting portion 76 and is generally sized to be capable of completely covering the flow window opening 64 in the valve body 52. The mounting portion 76 is mounted on the central portion 56 of the valve body 52 and is sandwiched between the base 68 of the limiter 54 and the central portion 56 of the valve body 52. The mounting of the reed petal 74 and limiter 54 on the valve body 52 is not particularly limited, and may be accomplished, for example, by two fasteners such as bolts 79 that are inserted through holes in the limiter 54, the reed petal 50, and the valve body 52 and secured by corresponding nuts 80. The mounting portion 76 of the reed petal 74 is therefore stationary, while the flapper portion 78 is free to move toward and away from the valve body 52 and between the valve body 52 and the limiter 54 with its maximum travel away from the valve body 52 limited by the limiter 54. The flapper portion 78 is thereby moveable between a closed disposition in which the flapper portion 78 is seated on the valve seat 66 of the valve body 52, and an open disposition in which the flapper portion 78 is lifted away from the valve seat 66. In the closed disposition, the flapper portion 78 prevents fluid flow from the second side 60 of the valve body 52 to the first side 58, while in the open disposition, the flapper portion 78 is separated from the periphery of the flow window opening 64 and allows for fluid flow from the first side 58 of the valve body 52 to the second side 60. In this manner, the reed valve 50 is a one-way flow valve.

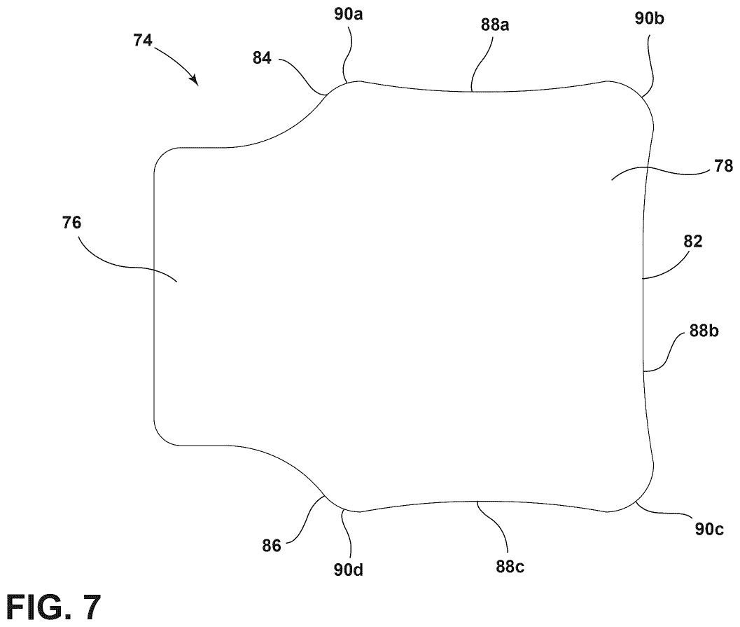

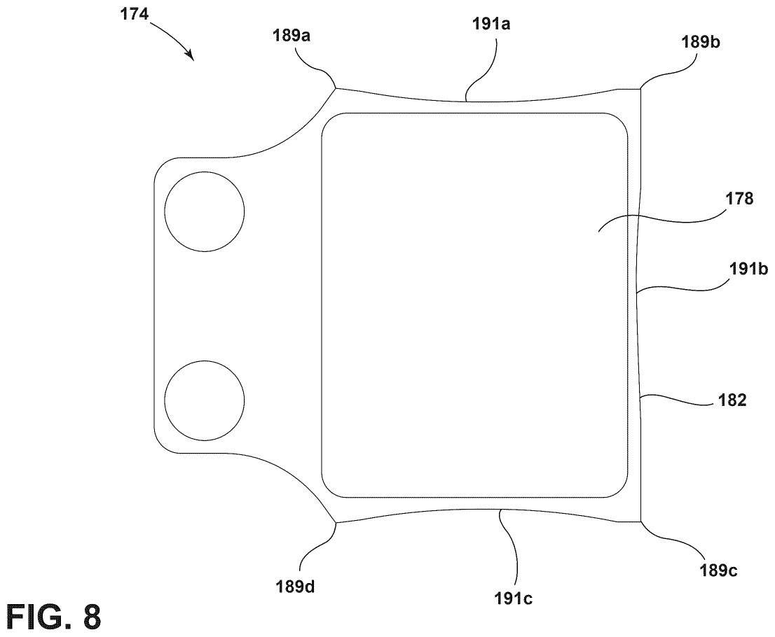

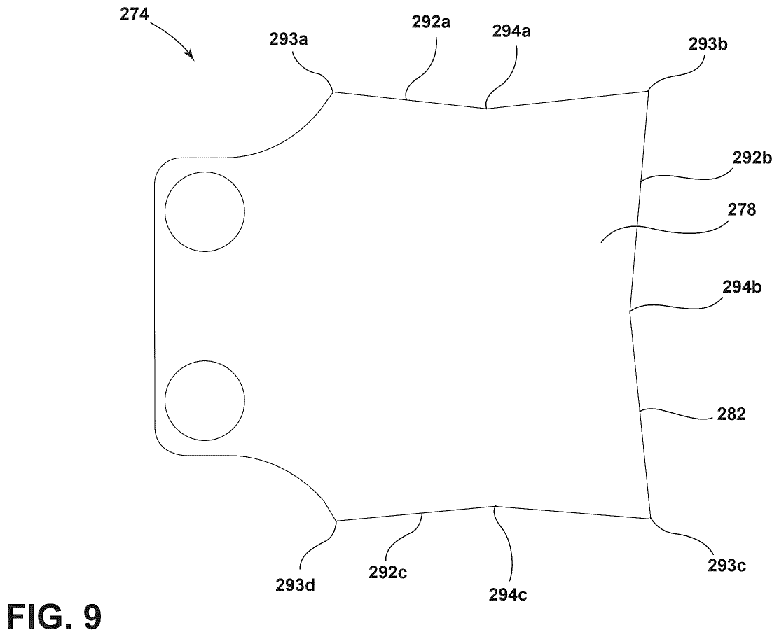

The flapper portion 78 of the reed petal 74 includes a peripheral edge 82 extending continuously from one end 84 of the mounting portion 76 to an opposite end 86 of the mounting portion 76. The peripheral edge 82 includes a plurality of sides. For example, as shown in FIG. 7, the peripheral edge 82 has three sides 88a, 88b, 88c and four corners 90a, 90b, 90c, 90d and each side extends between two neighboring corners. Particularly, side 88a extends between corners 90a, 90b, side 88b extends between corners 90b, 90c, and side 88c extends between corners 90c, 90d. At least one of the sides 88a, 88b, 88c is sloped between its corners, such as being sloped inward between its two corners, although it should be understood that the side(s) could alternatively be sloped outwardly. In contrast to conventional reed petals, at least one of the sides 88a, 88b, 88c of the flapper portion 78 of the reed valve 50 is not a straight line between its two neighboring corners 90a, 90b, 90c, 90d. For example, as shown by way of example in FIG. 7, each of the three sides 88a, 88b, 88c of the peripheral edge 82 is arcuately curved inward such that each side 88a, 88b, 88c has a smooth and uniform inward (towards the inside of the flapper portion 78) curvature from a corner at one end to the neighboring corner at the other end. In other embodiments as shown in FIG. 8, each of the three sides 191a, 191b, 191c of the peripheral edge 182 of the flapper portion 178 of the reed petal 174 may have a free form inward bend that is less uniform and that may be partially arcuate and partially linear. In yet other embodiments as shown in FIG. 9, each of the three sides 292a, 292b, 292c of the peripheral edge 282 of the flapper portion 278 of the reed petal 274 may be bent inward from two neighboring corners 293a, 293b, 293c, 293d to a point 294a, 294b, 294c. For example, each side 292a, 292b, 292c of the peripheral edge 282 may be V-shaped having two linear portions extending inward from the neighboring corners 293a, 293b, 293c, 293d and centrally meeting at the points 294a, 294b, 294c. In the various embodiments, the corners of the peripheral edge of the flapper portion may be rounded or pointed, or a combination of rounded and pointed. The corners 90a, 90b, 90c, 90d in the embodiments of FIG. 7 are rounded, whereas the corners 189a, 189b, 189c, 189d and the corners 293a, 293b, 293c, 293d in the embodiments of FIGS. 8 and 9 are pointed.

With reference again to FIGS. 2-7, the flow window opening 64 in the central portion 56 of the valve body 52 may be generally quadrilateral in shape. For example, the flow window opening 64 may have four sides, and each of the sides may be linear, straight sides. As such, the flow window opening 64 may be shaped as a square or rectangle. The flapper portion 78 of the reed petal 74 may also have a generally quadrilateral shape, which as discussed above, is larger in dimensions than the flow window opening 64 so that the flapper portion 78 can cover the flow window opening 64 in the closed disposition. However, as discussed above, at least one of the sides of the flapper portion 78 are sloped inward, and thus the flapper portion may only be square-like or rectangular-like.

In other embodiments not shown, the flapper portion of the reed petal may have straight sides rather than inwardly sloping sides, while the flow window opening instead has the inwardly sloping sides.

In the open disposition of the reed petal 74 of the reed valve 50, the peripheral edge 82 of the flapper portion 78 reduces vortex shedding in a flow of gas that passes through the flow window opening 64 of the reed valve 50. The inward slope and/or curvature of the peripheral edge 82 of the flapper portion 78 causes the gases passing through the reed valve 50 to flow more smoothly over and past the reed petal 74 by reducing turbulent flow. As such, the flapper portion 78 reduces the likelihood and amount of turbulent swirls, flow separation, and subsequent vortex formation downstream of the reed valve 50. Instead, the undulations in the peripheral edge 82 of the flapper portion 78 may generate relatively small vortices that stick the boundary layer to the surface of the reed petal 74, thereby reducing the formation of large, turbulent vortices. Also, the reduction in boundary layer separation leads to a reduction in drag on the gas stream through the reed valve 50, thereby reducing energy loss across the reed valve. The reduction in turbulence around the reed valve 50 may also reduce the degree of wear on the reed valve, and a lower pressure drop across the reed valve corresponds to a higher flow rate through the reed valve and hence to increased efficiency.

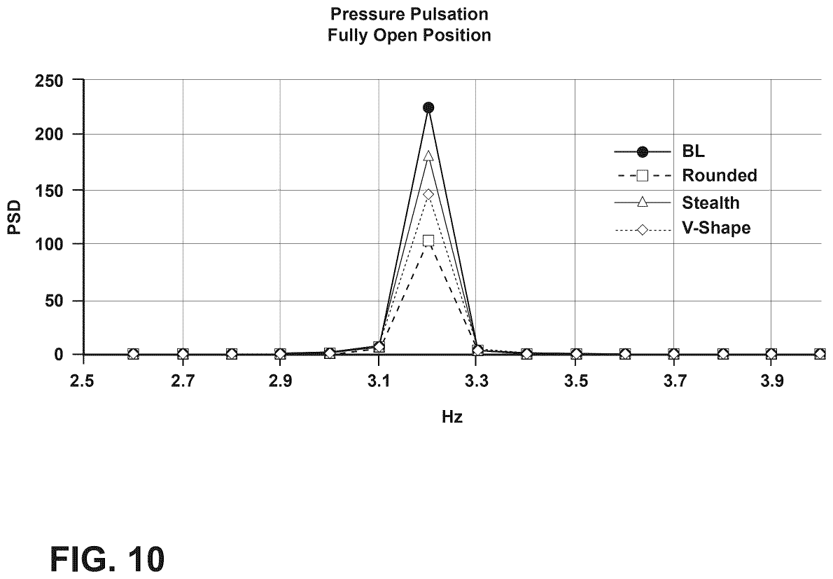

With reference to FIG. 10, by way of example only, a modeled sinusoidal flow with a velocity profile of 0.5*Sin(20t) was applied to reed valves having a flapper portion 78, 178, 278 (flapper portion 78 corresponding to “Rounded”; flapper portion 178 corresponding to “Stealth”; flapper portion 278 corresponding to “V-Shape”) as well as a conventional reed valve having a conventional flapper portion (corresponding to baseline “BL”). This example is not intended to be limiting, and it should be understood that other velocity profiles or boundary conditions such as velocity or pressure could be applied. Each of the flapper portions 78, 178, 278 exhibited a lower pressure pulsation in the fully open disposition in comparison to the conventional baseline flapper portion, as shown by the Power Spectral Density (PSD) values on the y-axis of the graph obtained by applying the exemplary sinusoidal flow. The “Rounded” flapper portion 78 exhibited the lowest pressure pulsation, which was more than two times lower than the baseline flapper portion. A lower pressure pulsation corresponds to less vibration of the flapper portion and thus a reduction of noise and quieter operation of the reed valve.

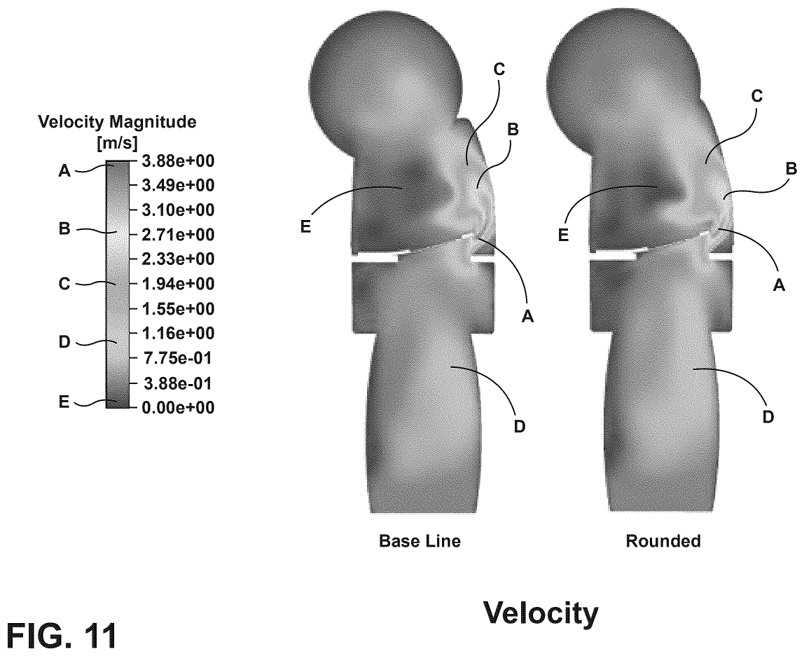

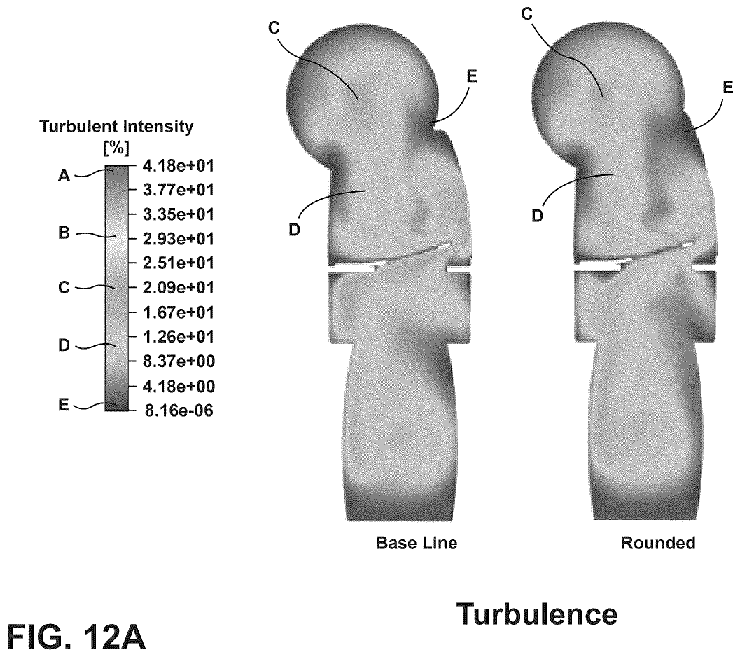

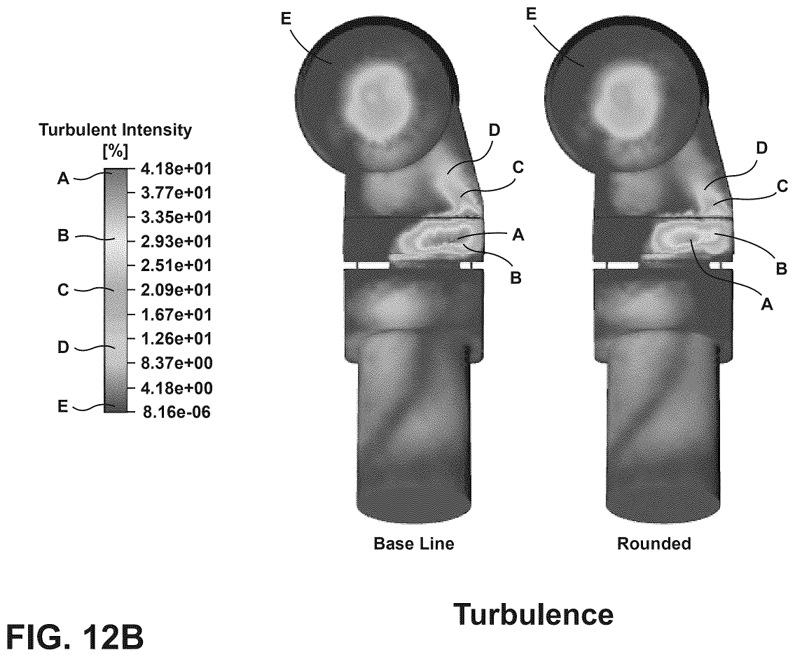

With reference to FIGS. 11, 12A, and 12B, the reed valve 50 with the “Rounded” flapper portion 78 exhibited a decrease in gas flow velocity downstream from the reed valve 50 in comparison to a conventional reed valve having a conventional flapper potion (“Base Line”). The “Rounded” flapper portion 78 also exhibited lower turbulence downstream from the reed valve 50 in comparison to the conventional reed valve. Velocity magnitude regions A, B, C, D, and E, with region A having the highest velocity amongst the regions in m/s and region E having the lowest, are shown in FIG. 11. Turbulence intensity regions A, B, C, D, and E in percent intensity are shown in FIGS. 12A and 12B, with region A having the highest turbulence amongst the regions and region E having the lowest turbulence.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements by ordinal terms, for example “first,” “second,” and “third,” are used for clarity, and are not to be construed as limiting the order in which the claim elements appear. Any reference to claim elements in the singular, for example, using the articles “a,” “an,” “the” or “said,” is not to be construed as limiting the element to the singular.

What is claimed is:

1. A reed valve for one-way flow of gas, the reed valve comprising:
a valve body; and
a reed petal including a mounting portion and an adjacent flapper portion, the mounting portion being mounted on the valve body;
the valve body including a flow window opening and having a surface surrounding a periphery of the flow window opening and defining a valve seat for the reed petal;
wherein the flapper portion of the reed petal includes a peripheral edge extending continuously from one end of the mounting portion to an opposite end of the mounting portion of the reed petal, the peripheral edge includes a plurality of sides, and at least one of the sides is sloped inward;
wherein the flapper portion is moveable between a closed disposition in which the flapper portion is seated on the valve seat and an open disposition in which the flapper portion is lifted away from the valve seat, and in the open disposition the peripheral edge of the flapper portion reduces vortex shedding in a flow of gas downstream from the flow window opening of the reed valve.

2. The reed valve of claim 1, wherein the at least one side of the peripheral edge is arcuately curved inward.

3. The reed valve of claim 1, wherein the peripheral edge includes at least three corners, and each of the plurality of sides of the peripheral edge extends between two neighboring corners.

4. The reed valve of claim 3, wherein the peripheral edge includes four corners and three sides, each of the three sides extending between two neighboring corners.

5. The reed valve of claim 4, wherein each of the three sides of the peripheral edge is arcuately curved inward.

6. The reed valve of claim 3, wherein: i) one or more of the corners of the peripheral edge is rounded; ii) one or more of the corners of the peripheral edge is pointed; or iii) both i) and ii).

7. The reed valve of claim 3, wherein the at least one side of the peripheral edge is bent inward from two neighboring corners to a point.

8. The reed valve of claim 7, wherein the at least one side of the peripheral edge is V-shaped.

9. The reed valve of claim 1, wherein the flapper portion of the reed petal is larger than the mounting portion of the reed petal.

10. The reed valve of claim 1, wherein the flapper portion of the reed petal has a generally quadrilateral shape.

11. The reed valve of claim 1, wherein the flow window opening in the valve body is generally quadrilateral in shape.

12. The reed valve of claim 11, wherein the flow window opening in the valve body has four sides, each side being straight.

13. The reed valve of claim 1, further comprising a limiter mounted on the valve body, wherein the reed petal is disposed between the valve body and the limiter.

14. The reed valve of claim 13, wherein the limiter includes a base and an adjacent stop, the base being mounted on the valve body, and the stop extending at an angle from the base and being spaced from the valve body.

15. A fuel cell system comprising:
a fuel cell stack including a membrane electrode assembly;
a cathode air supply subsystem that supplies air to the fuel cell stack;
an anode hydrogen supply subsystem that supplies hydrogen gas to the fuel cell stack;
wherein the anode hydrogen supply subsystem includes a source of high-pressure hydrogen gas and an ejector having an inlet connected to the source of high-pressure hydrogen gas and an outlet connected to an anodic inlet of the fuel cell stack;
wherein the anode hydrogen supply subsystem further includes an anodic recirculation subsystem, the anodic recirculation subsystem including:
a water separator having an inlet connected to an anodic outlet of the fuel cell stack; and
the reed valve of claim 1 disposed between the water separator and an inlet of the ejector.

16. The fuel cell system of claim 15, wherein the reed valve is assembled directly between the water separator and the ejector.

17. The fuel cell system of claim 15, wherein the reed valve is press fit between the water separator and the ejector.
